(19) United States
(12) Patent Application Publication
(10) Pub. No.: US 2015/0189523 A1
(43) Pub. Date: Jul. 2, 2015

(54) COMMUNICATION TERMINAL AND METHOD FOR REPORTING MEASUREMENT RESULTS

(71) Applicant: Intel IP Corporation, Santa Clara, CA (US)

(72) Inventors: Juergen MICHEL, Muenchen (DE); Bernhard Raaf, Neuried (DE); Thorsten CLEVORN, Muenchen (DE)

(21) Appl. No.: 14/141,562

(22) Filed: Dec. 27, 2013

(51) Int. Cl. H04W 24/08; H04W 24/10

(52) U.S. Cl. CPC H04W 24/08; H04W 24/10

(57) ABSTRACT

A communication terminal is for example described comprising a determiner configured to determine a first candidate measurement timing pattern and a second candidate measurement timing pattern, each measurement timing pattern comprising a plurality of measurement times, wherein the second measurement timing pattern comprises at least one measurement time occurring between a plurality of measurement times of the first candidate measurement timing pattern; a selector configured to select, from the first and the second candidate measurement timing pattern, a pattern with a measurement time at which a result of a measurement fulfills a reporting criterion and which fulfills a predetermined condition and a controller configured to control a measurement reporting circuit to report cell measurement results based on the selected measurement timing pattern.

### TECHNICAL FIELD

The present disclosure described herein generally relates to communication terminals and methods for reporting measurement results.

### BACKGROUND

A typical functionality of a communication terminal of a mobile communication system is the measuring of the signal strength or signal quality at the communication terminal of signals transmitted by its serving cell and neighboring cells for checking whether it is to perform a handover. Since it may be beneficial for a communication terminal to stay in a certain cell as long as possible or leave the certain cell as early as possible (i.e. to have a handover to another cell) approaches that allow a communication terminal to accelerate or delay a handover are desirable.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various aspects are described with reference to the following drawings, in which:

FIG. 1 shows a communication system according to a mobile communication standard, such as LTE.

FIG. 2 shows an exemplary communication terminal.

FIG. 3 shows a flow diagram illustrating an exemplary method for reporting measurement results.

FIG. 4 shows a message flow diagram illustrating the measurement control and reporting prior to handover preparation and the message exchange during the handover preparation.

FIG. 5 shows a measurement processing arrangement.

FIG. 6 shows a diagram illustrating UE measurement reporting for a reporting trigger event according to 3GPP.

FIG. 7 shows a flow diagram illustrating a reduction of the reporting delay in case of entering a reporting condition.

FIG. 8 shows a flow diagram illustrating an increase of the reporting delay in case of entering a reporting condition.

FIG. 9 shows a flow diagram illustrating a reduction of the reporting delay in case of leaving a reporting condition.

FIG. 10 shows a flow diagram illustrating an increase of the reporting delay in case of leaving a reporting condition.

### DESCRIPTION OF EMBODIMENTS

The following detailed description refers to the accompanying drawings that show, by way of illustration, specific details and aspects of this disclosure in which the invention may be practiced. Other aspects may be utilized and structural, logical, and electrical changes may be made without departing from the scope of the invention. The various aspects of this disclosure are not necessarily mutually exclusive, as some aspects of this disclosure can be combined with one or more other aspects of this disclosure to form new aspects.

For reasons of simplicity, in the following, explanations will be given using a mobile communication standard or radio access technology, such as LTE according to 3GPP (3^{rd} Generation Partnership Project) and the corresponding entities (e.g. E-UTRAN, EPC and UE), however, it is to be noted that various aspects may also be provided using another cellular wide area radio communication technology and its corresponding entities and corresponding nomenclature as will be described in more detail below.

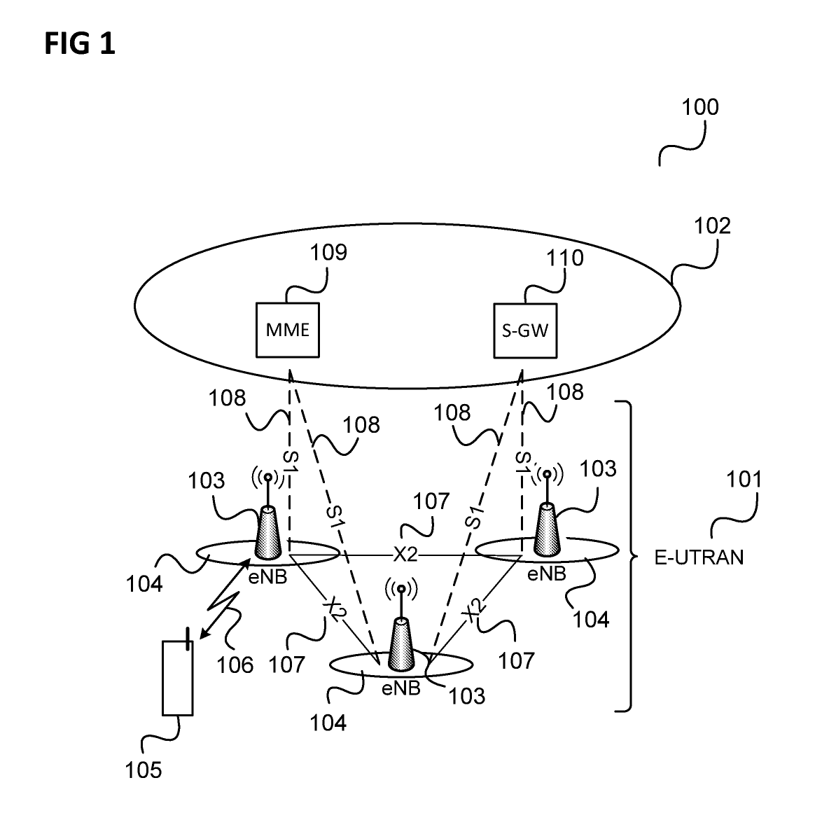

FIG. 1 shows an exemplary communication system 100.

The communication system 100 may be a cellular mobile communication system (also referred to as cellular radio communication network in the following) including a radio access network (e.g. an E-UTRAN, Evolved UMTS (Universal Mobile Communications System) Terrestrial Radio Access Network according to LTE (Long Term Evolution), or LTE-Advanced) 101 and a core network (e.g. an EPC, Evolved Packet Core, according LTE, or LTE-Advanced) 102. The radio access network 101 may include base stations (e.g. base transceiver stations, eNodeBs, eNBs, home base stations, Home eNodeBs, HeNBs according to LTE, or LTE-Advanced) 103. Each base station 103 may provide radio coverage for one or more mobile radio cells 104 of the radio access network 101. In other words: The base stations 103 of the radio access network 101 may span different types of cells 104 (e.g. macro cells, femto cells, pico cells, small cells, open cells, closed subscriber group cells, hybrid cells, for instance according to LTE, or LTE-Advanced).

A mobile terminal (e.g. UE) 105 located in a mobile radio cell 104 may communicate with the core network 102 and with other mobile terminals 105 via the base station 103 providing coverage in (in other words operating) the mobile radio cell 104. In other words, the base station 103 operating the mobile radio cell 104 in which the mobile terminal 105 is located may provide the E-UTRA user plane terminations including the PDCP (Packet Data Convergence Protocol) layer, the RLC (Radio Link Control) layer and the MAC (Medium Access Control) layer and control plane terminations including the RRC (Radio Resource Control) layer towards the mobile terminal 105.

Control and user data may be transmitted between a base station 103 and a mobile terminal 105 located in the mobile radio cell 104 operated by the base station 103 over the air interface 106 on the basis of a multiple access method. On the LTE air interface 106 different duplex methods, such as FDD (Frequency Division Duplex) or TDD (Time Division Duplex), may be deployed.

The base stations 103 may be interconnected with each other by means of a first interface 107, e.g. an X2 interface. The base stations 103 are also connected by means of a second interface 108, e.g. an S1 interface, to the core network 102, e.g. to an MME (Mobility Management Entity) 109 via an S1-MME interface 108 and to a Serving Gateway (S-GW) 110 by means of an S1-U interface 108. The S1 interface 108 supports a many-to-many relation between MMEs/S-GWs 109, 110 and the base stations 103, i.e. a base station 103 may be connected to more than one MME/S-GW 109, 110 and an MME/S-GW 109, 110 may be connected to more than one base station 103. This may enable network sharing in LTE.

For example, the MME 109 may be responsible for controlling the mobility of mobile terminals located in the coverage area of E-UTRAN, while the S-GW 110 may be responsible for handling the transmission of user data between mobile terminals 105 and the core network 102.

In case of a mobile communication standard, such as LTE, the radio access network 101, i.e. the E-UTRAN 101 in case of LTE, may be seen to consist of the base station 103, i.e. the eNBs 103 in case of LTE, providing the E-UTRA user plane (PDCP/RLC/MAC) and control plane (RRC) protocol terminations towards the UE 105.

Each base station 103 of the communication system 100 may control communications within its geographic coverage area, namely its mobile radio cell 104 that is ideally represented by a hexagonal shape. When the mobile terminal 105 is located within a mobile radio cell 104 and is camping on the mobile radio cell 104 (in other words is registered with a Tracking Area (TA) assigned to the mobile radio cell 104) it communicates with the base station 103 controlling that mobile radio cell 104. When a call is initiated by the user of the mobile terminal 105 (mobile originated call) or a call is addressed to the mobile terminal 105 (mobile terminated call), radio channels are set up between the mobile terminal 105 and the base station 103 controlling the mobile radio cell 104 in which the mobile station is located. If the mobile terminal 105 moves away from the original mobile radio cell 104 in which a call was set up and the signal strength of the radio channels established in the original mobile radio cell 104 weakens, the communication system may initiate a transfer of the call to radio channels of another mobile radio cell 104 into which the mobile terminal 105 moves.

As the mobile terminal 105 continues to move throughout the coverage area of the communication system 100, control of the call may be transferred between neighboring mobile radio cells 104. The transfer of calls from mobile radio cell 104 to mobile radio cell 104 is termed handover (or handoff).

A communication system, such as system 100 with LTE capability, can provide users reliable services with improved data rate performance compared to legacy systems like UMTS, HSPA or GSM. With today's rollout and installation, LTE systems typically can be characterized by service hot spot deployments and local coverage areas. Full scale coverage of LTE will still take time and legacy systems will serve the mobility demands in many areas for years to come. For these reasons mobility scenarios across local hot spots (pico cells) and coverage deployments (macro cells) can be expected to be important for future optimization.

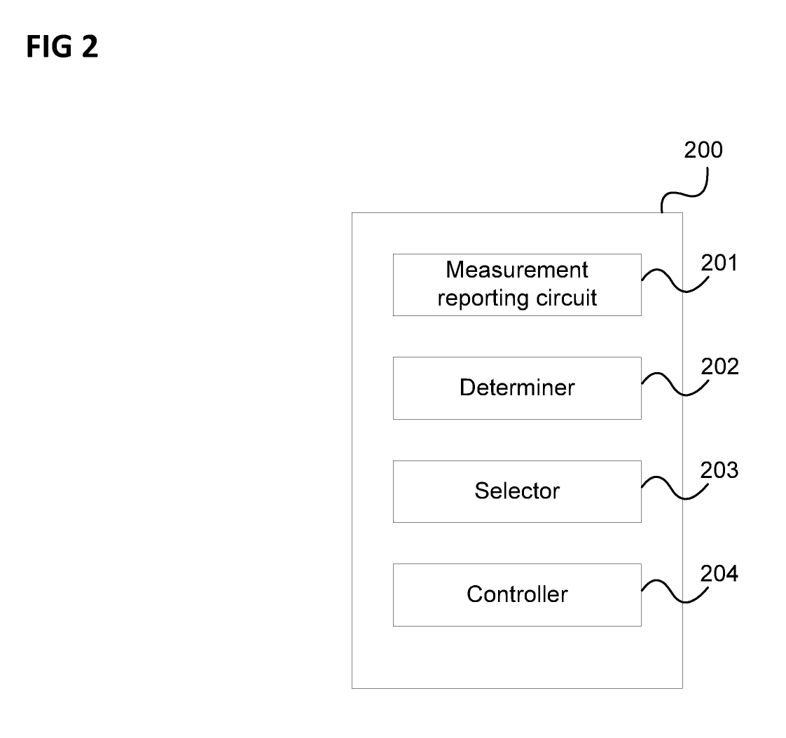

A communication terminal is for example provided as illustrated in FIG. 2 which can be seen to address these scenarios and corresponding demands regarding handover procedures.

FIG. 2 shows an exemplary communication terminal 200.

The communication terminal 200 includes a measurement reporting circuit 201 configured to report a plurality of cell measurement results based on a measurement timing pattern.

The communication terminal 200 further includes a determiner 202 configured to determine a first candidate measurement timing pattern and a second candidate measurement timing pattern, each measurement timing pattern including a plurality of measurement times, wherein the second measurement timing pattern includes at least one measurement time occurring between a plurality of measurement times of the first candidate measurement timing pattern i.e. the second measurement timing pattern is for example offset or shifted relative to the first candidate measurement timing pattern.

Further, the communication terminal 200 includes a selector 203 configured to select, from the first candidate measurement timing pattern and the second candidate measurement timing pattern, a measurement timing pattern with a measurement time at which a result of a measurement fulfills a reporting criterion and which (i.e. the measurement time) fulfills a predetermined condition and a controller 204 configured to control the measurement reporting circuit to report the plurality of cell measurement results based on the selected measurement timing pattern.

In other words, a communication terminal is configured to choose the measurement timing pattern according to which it reports measurements, e.g. cell measurements for a handover procedure, automatically from a plurality of possible measurement timing patterns. This in effect allows the communication terminal to adapt the time of reporting or the delay of the reporting. The communication terminal can be seen to adapt measurement parameters in order to adjust the reporting timing.

This for example allows an adaptive timing optimized handover procedure where an adaptive delay is under control of the UE (or generally the communication terminal) and may be optimized from the point of view of the UE. The UE can for example perform an optimization (or generally an adaptation) of the delay either always (e.g. for each handover procedure) and without further fine-tuning or depending on the radio scenario. It should be noted that the communication terminal may be seen to operate within the spirit of the rules given in a mobile communication standard, such as the 3GPP (3^{rd} Generation Partnership Project) standard, while it allows additional optimizations taking pre-knowledge or preferences into account thus for example allowing UE vendors to differentiate.

The communication terminal, for example, allows for an enhanced user perception in terms of delay and throughput especially in hierarchical and multi RAT (Radio Access Technology) deployments. Further, it may allow mitigating the problems arising from TCP (Transmission Control Protocol) connections being very sensitive to interruptions and for example ensuring a more seamless throughput perception during handover.

The communication terminal 200 may for example adapt the trigger based measurement reporting delay for a handover dependent on certain trigger criteria. Adaptation for example means that the communication terminal is either increasing or reducing the measurement reporting delay depending on the situation and thus speeds up or delays a subsequent handover. The delay adaptation can be done before or after a measurement filtering (e.g. at layers above layer 1, e.g. layer 3) using interpolation and/or extrapolation. In this way it may be implemented to be compatible with the 3GPP standardization (even though the 3GPP standard does not foresee such optimizations). Therefore, it can be implemented at little risk of incompatibilities with network implementations.

A case in which the UE decides to reduce the reporting delay may for example be that the UE detects a hotspot and therefore tries to handover as quickly as possible to benefit from a higher throughput offered by the hotspot.

A case in which the UE decides to increase the reporting delay may for example be that the UE is connected to a hotspot and the UE knows the macro cell which would be the target of a handover (e.g. an overlaying macro cell). In this case the layer 1 synchronization to the neighbor cell (i.e. the macro cell) may be carried out faster (compared to a handover to an unknown cell) and therefore a delayed measurement report can be justified by gaining a bit longer from the higher throughput when serviced by the hotspot before eventually initiating the handover.

It should be noted that the approach described above with reference to FIG. 2 can be implemented without needing radical changes in the protocols, terminal implementation or network architecture.

It should further be noted that if a determination or selection of a finite measurement timing pattern may be seen as a determination and selection of its extrapolated or extended (i.e. periodically continued) version.

For example, if a first measurement timing pattern for example includes the times 1, 2, 3, 4 and a second measurement timing pattern includes the times 11.5, 12.5, 13.5 and 14.5 even though none of the times of the second pattern lies between two times of the first pattern, a determination of these patterns may still be seen to as a determination of a first candidate measurement timing pattern and a second candidate measurement timing pattern, wherein the second measurement timing pattern includes at least one measurement time occurring between a plurality of measurement times of the first candidate measurement timing pattern. This is because the determination of the first measurement timing pattern 1, 2, 3, 4 can be seen as the determination of a first candidate measurement timing pattern that includes all times 1, 2, 3, 4, 5, 6, 7, 8, 9, 10, 11, 12, 13, 14, . . . (i.e. the determination of the first measurement timing pattern may be seen to characterize or correspond to its extrapolated version). With this interpretation of the first measurement timing pattern, the measurement patterns fulfill that the second measurement timing pattern includes at least one measurement time occurring between a plurality of measurement times of the first candidate measurement timing pattern (since, for example 11.5 lies, i.e. occurs, between 11 and 12). A measurement timing lying or occurring between a plurality of other measurement times may for example be understood as at least one measurement time of the plurality of other measurement times being earlier than the measurement timing and at least one measurement time of the plurality of other measurement times being later than the measurement timing.

The first candidate measurement timing pattern is for example a measurement timing pattern according to which the measurement reporting circuit has previously (i.e. earlier) reported cell measurement results. The selection of the second candidate measurement timing pattern and reporting according to the second candidate measurement timing pattern may thus be seen as a switching from a first measurement timing pattern to a (shifted) second measurement timing pattern. It should further be noted that the switching from one measurement timing pattern (used earlier) to another measurement timing pattern may be seen as including a determination of both measurement timing patterns (and a selection of the other measurement timing pattern). Since the measurement timing pattern used earlier has been known at some time by the communication terminal, it can be seen to have been determined by the communication terminal. This is in particular the case if the shift of the second pattern relative to the first pattern is not done randomly or in a predetermined way that is independent of the measurements but the shift is done in dependence of actual measurements.

The components of the communication terminal (e.g. the determiner, the selector and the controller) may for example be implemented by one or more circuits. A “circuit” may be understood as any kind of a logic implementing entity, which may be special purpose circuitry or a processor executing software stored in a memory, firmware, or any combination thereof. Thus a “circuit” may be a hard-wired logic circuit or a programmable logic circuit such as a programmable processor, e.g. a microprocessor. A “circuit” may also be a processor executing software, e.g. any kind of computer program. Any other kind of implementation of the respective functions which will be described in more detail below may also be understood as a “circuit”.

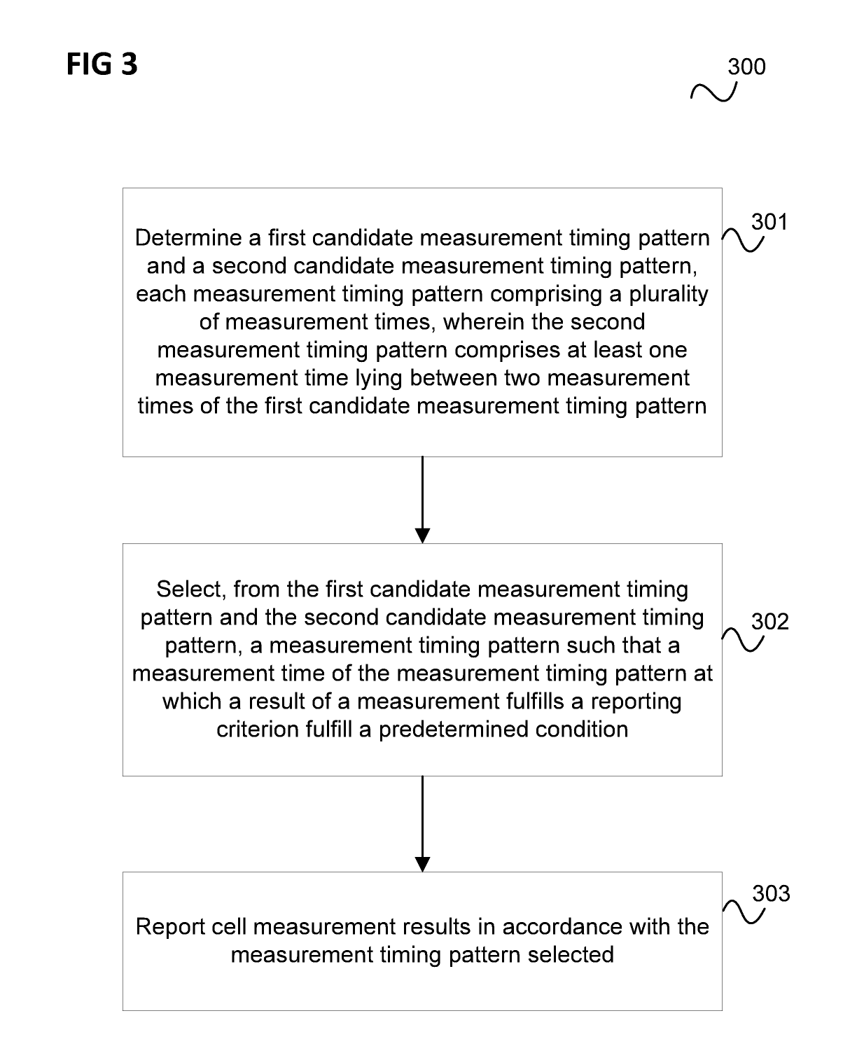

The communication terminal 200 for example carries out a method as illustrated in FIG. 3.

FIG. 3 shows an exemplary flow diagram 300 for a method for reporting measurement results.

The flow diagram 300 illustrates a method for reporting measurement results, for example carried out by a communication terminal.

In 301, the communication terminal determines a first candidate measurement timing pattern and a second candidate measurement timing pattern, each measurement timing pattern including a plurality of measurement times, wherein the second measurement timing pattern includes at least one measurement time occurring between a plurality of measurement times of the first candidate measurement timing pattern.

In 302, the communication terminal selects, from the first candidate measurement timing pattern and the second candidate measurement timing pattern, a measurement timing pattern with a measurement time at which a result of a measurement fulfills a reporting criterion and which (i.e. the measurement time) fulfills a predetermined condition.

In 303, the communication terminal reports a plurality of cell measurement results based on the selected measurement timing pattern.

The following examples pertain to further embodiments.

Example 1 is a communication terminal as illustrated in FIG. 2.

In Example 2, the subject matter of Example 1 can optionally include the determiner being configured to determine at least one further candidate measurement timing pattern, wherein the at least one further candidate measurement timing pattern comprises at least one measurement time occurring between a plurality of measurement times of the first candidate measurement timing pattern and comprises at least one measurement time occurring between a plurality of measurement times of the second candidate measurement timing pattern.

In Example 3, the subject matter of any one of Examples 1-2 can optionally include the reporting criterion being a criterion for triggering a reporting of the plurality of cell measurement results.

In Example 4, the subject matter of any one of Examples 1-3 can optionally include the measurement reporting circuit being configured to report the plurality of cell measurement results to a base station.

In Example 5, the subject matter of any one of Examples 1-4 can optionally include the predetermined condition being that, for a given fulfillment of the reporting criterion, the measurement time of the measurement timing pattern is the earliest time at which the result of the measurement fulfills the reporting criterion among the times included in the candidate measurement timing patterns.

In Example 6, the subject matter of any one of Examples 1-5 can optionally include the predetermined condition being that, for a given fulfillment of the reporting criterion, the measurement times of the measurement timing pattern comprise a latest time at which the result of the measurement has yet to fulfill the reporting criterion among the times included in the candidate measurement timing patterns and the measurement time is the first time of the measurement timing pattern following the latest time.

In Example 7, the subject matter of any one of Examples 1-6 can optionally include the determiner being configured to determine the first candidate measurement timing pattern by determining the measurement timing pattern of a physical layer component of the communication terminal as the first candidate measurement timing pattern.

In Example 8, the subject matter of any one of Examples 1-7 can optionally include the determiner being configured to determine the second candidate measurement timing pattern by shifting the first candidate measurement timing pattern by a time interval less than the time interval between a plurality of measurement timings of the first candidate measurement timing pattern.

In Example 9, the subject matter of any one of Examples 1-8 can optionally include the determining the second candidate measurement timing pattern comprising estimating the time at which a result of a measurement fulfills a reporting criterion and determining the second candidate measurement timing based on the estimated time.

In Example 10, the subject matter of Example 9 can optionally include the determiner being configured to determine the second candidate measurement timing pattern to include the estimated time.

In Example 11, the subject matter of any one of Examples 9-10 can optionally include the determiner being configured to determine the second candidate measurement timing pattern to exclude the estimated time.

In Example 12, the subject matter of any one of Examples 9-11 can optionally include the determiner being configured to determine the second candidate measurement timing pattern to include a measurement time before the estimated time but after the latest measurement timing of the first candidate measurement timing before the estimated time.

In Example 13, the subject matter of any one of Examples 1-12 can optionally include the first candidate measurement timing and the second candidate measurement timing being periodic.

In Example 14, the subject matter of any one of Examples 1-13 can optionally include the communication terminal being configured to operate based on a communication standard that specifies the time interval between a plurality of measurement times of a measurement timing pattern used for reporting measurements.

In Example 15, the subject matter of any one of Examples 1-14 can optionally include the measurement results being results of measurements for evaluating whether the communication terminal is to perform a handover.

In Example 16, the subject matter of any one of Examples 1-15 can optionally include the measurement being the measurement of the reception power or the reception quality of a signal at the communication terminal and the reporting criterion being whether the reception power or the reception quality is above or below a predetermined threshold.

In Example 17, the subject matter of any one of Examples 1-16 can optionally include the communication terminal being a user equipment according to an LTE specification.

In Example 18, the subject matter of any one of Examples 1-17 can optionally include the first candidate measurement timing pattern being a measurement timing pattern according to which the measurement reporting circuit has previously reported cell measurement results.

In Example 19, the subject matter of any one of Examples 1-18 can optionally include the measurement reporting circuit being configured to report the plurality of cell measurement results to an eNB according to an LTE specification.

Example 20 is a method for reporting measurement results as illustrated in FIG. 3.

In Example 21, the subject matter of Examples 20 can optionally include determining at least one further candidate measurement timing pattern, wherein the at least one further candidate measurement timing pattern comprises at least one measurement time occurring between a plurality of measurement times of the first candidate measurement timing pattern and comprises at least one measurement time occurring between a plurality of measurement times of the second candidate measurement timing pattern.

In Example 22, the subject matter of any one of Examples 20-21 can optionally include the reporting criterion being a criterion for triggering a reporting of the plurality of cell measurement results.

In Example 23, the subject matter of any one of Examples 20-22 can optionally include reporting the cell measurement results to a base station.

In Example 24, the subject matter of any one of Examples 20-23 can optionally include the predetermined condition being that, for a given fulfillment of the reporting criterion, the measurement time of the measurement timing pattern is the earliest time at which the result of the measurement fulfills the reporting criterion among the times included in the candidate measurement timing patterns.

In Example 25, the subject matter of any one of Examples 20-24 can optionally include the predetermined condition being that, for a given fulfillment of the reporting criterion, the measurement times of the measurement timing pattern comprise a latest time at which the result of the measurement has yet to fulfill the reporting criterion among the times included in the candidate measurement timing patterns and the measurement time is the first time of the measurement timing pattern following the latest time.

In Example 26, the subject matter of any one of Examples 20-25 can optionally include determining the first candidate measurement timing pattern by determining the measurement timing pattern of a physical layer component of the communication terminal as the first candidate measurement timing pattern.

In Example 27, the subject matter of any one of Examples 20-26 can optionally include determining the second candidate measurement timing pattern by shifting the first candidate measurement timing pattern by a time interval less than the time interval between a plurality of measurement timings of the first candidate measurement timing pattern.

In Example 28, the subject matter of any one of Examples 20-27 can optionally include estimating the time at which a result of a measurement fulfills a reporting criterion and determining the second candidate measurement timing based on the estimated time.

In Example 29, the subject matter of Example 28 can optionally include determining the second candidate measurement timing pattern to include the estimated time.

In Example 30, the subject matter of any one of Examples 28-29 can optionally include determining the second candidate measurement timing pattern to exclude the estimated time.

In Example 31, the subject matter of any one of Examples 28-30 can optionally include determining the second candidate measurement timing pattern to include a measurement time before the estimated time but after the latest measurement timing of the first candidate measurement timing before the estimated time.

In Example 32, the subject matter of any one of Examples 20-31 can optionally include the first candidate measurement timing and the second candidate measurement timing being periodic.

In Example 33, the subject matter of any one of Examples 20-32 can optionally include operating based on a communication standard that specifies the time interval between a plurality of measurement times of a measurement timing pattern used for reporting measurements.

In Example 34, the subject matter of any one of Examples 20-233 can optionally include the measurement results being results of measurements for evaluating whether a communication terminal is to perform a handover.

In Example 35, the subject matter of any one of Examples 20-34 can optionally include the measurement being the measurement of the reception power or the reception quality of a signal at a communication terminal and the reporting criterion being whether the reception power or the reception quality is above or below a predetermined threshold.

In Example 36, the subject matter of any one of Examples 20-35 can optionally include reporting the plurality of cell measurement results to an eNB according to an LTE specification.

In Example 37, the subject matter of any one of Examples 20-36 can optionally include the first candidate measurement timing pattern being a measurement timing pattern according to which cell measurement results have previously been reported.

Example 38 is a computer readable medium having recorded instructions thereon which, when executed by a processor, make the processor perform a method for performing radio communication according to any one of Examples 20 to 37.

Example 39 is a communication terminal comprising measurement reporting means for reporting a plurality of cell measurement results based on a measurement timing pattern; determining means for determining a first candidate measurement timing pattern and a second candidate measurement timing pattern, each measurement timing pattern comprising a plurality of measurement times, wherein the second measurement timing pattern comprises at least one measurement time occurring between a plurality of measurement times of the first candidate measurement timing pattern; selecting means for selecting, from the first candidate measurement timing pattern and the second candidate measurement timing pattern, a measurement timing pattern with a measurement time at which a result of a measurement fulfills a reporting criterion and which fulfills a predetermined condition; and controlling means for controlling the measurement reporting means to report the plurality of cell measurement results based on the selected measurement timing pattern.

In Example 40, the subject matter of Example 39 can optionally include the determining means being configured to determine at least one further candidate measurement timing pattern, wherein the at least one further candidate measurement timing pattern comprises at least one measurement time occurring between a plurality of measurement times of the first candidate measurement timing pattern and comprises at least one measurement time occurring between a plurality of measurement times of the second candidate measurement timing pattern.

In Example 41, the subject matter of any one of Examples 39-40 can optionally include the reporting criterion being a criterion for triggering a reporting of the plurality of cell measurement results.

In Example 42, the subject matter of any one of Examples 39-41 can optionally include the measurement reporting means being configured to report the plurality of cell measurement results to a base station.

In Example 43, the subject matter of any one of Examples 39-42 can optionally include the predetermined condition being that, for a given fulfillment of the reporting criterion, the measurement time of the measurement timing pattern is the earliest time at which the result of the measurement fulfills the reporting criterion among the times included in the candidate measurement timing patterns.

In Example 44, the subject matter of any one of Examples 39-43 can optionally include the predetermined condition being that, for a given fulfillment of the reporting criterion, the measurement times of the measurement timing pattern comprise a latest time at which the result of the measurement has yet to fulfill the reporting criterion among the times included in the candidate measurement timing patterns and the measurement time is the first time of the measurement timing pattern following the latest time.

In Example 45, the subject matter of any one of Examples 39-44 can optionally include the determining means being configured to determine the first candidate measurement timing pattern by determining the measurement timing pattern of a physical layer component of the communication terminal as the first candidate measurement timing pattern.

In Example 46, the subject matter of any one of Examples 39-45 can optionally include the determining means being configured to determine the second candidate measurement timing pattern by shifting the first candidate measurement timing pattern by a time interval less than the time interval between a plurality of measurement timings of the first candidate measurement timing pattern.

In Example 47, the subject matter of any one of Examples 39-46 can optionally include determining the second candidate measurement timing pattern comprising estimating the time at which a result of a measurement fulfills a reporting criterion and determining the second candidate measurement timing based on the estimated time.

In Example 48, the subject matter of Example 47 can optionally include the determining means being configured to determine the second candidate measurement timing pattern to include the estimated time.

In Example 49, the subject matter of any one of Examples 47-48 can optionally include the determining means being configured to determine the second candidate measurement timing pattern to exclude the estimated time.

In Example 50, the subject matter of any one of Examples 47-49 can optionally include the determining means are configured to determine the second candidate measurement timing pattern to include a measurement time before the estimated time but after the latest measurement timing of the first candidate measurement timing before the estimated time.

In Example 51, the subject matter of any one of Examples 39-50 can optionally include the first candidate measurement timing and the second candidate measurement timing being periodic.

In Example 52, the subject matter of any one of Examples 39-51 can optionally include the communication terminal being configured to operate based on a communication standard that specifies the time interval between a plurality of measurement times of a measurement timing pattern used for reporting measurements.

In Example 53, the subject matter of any one of Examples 39-52 can optionally include the measurement results being results of measurements for evaluating whether the communication terminal is to perform a handover.

In Example 54, the subject matter of any one of Examples 39-53 can optionally include the measurement being the measurement of the reception power or the reception quality of a signal at the communication terminal and the reporting criterion being whether the reception power or the reception quality is above or below a predetermined threshold.

In Example 55, the subject matter of any one of Examples 39-54 can optionally include the communication terminal being a user equipment according to an LTE specification.

In Example 56, the subject matter of any one of Examples 39-55 can optionally include the measurement reporting means being configured to report the plurality of cell measurement results to an eNB according to an LTE specification.

It should be noted that one or more of the features of any of the examples above may be combined with any one of the other examples.

In the following, examples for the communication terminal 200 and the method illustrated in FIG. 3 are described in more detail.

According to LTE (or 4G) the handover procedure is typically divided into three phases: the preparation, execution and the completion phase. The main possibilities where a UE can impact and reduce the handover delay is during the delivery of measurements for the handover preparation phase and during the execution phase when the UE establishes the synchronization to the target cell, i.e. synchronize the downlink (DL) and tunes the timing advance via the RACH (Random Access Channel) procedure. A typical interruption time for an LTE handover for synchronization to the target cell (including the radio switch over) is in the range of about 8 ms if the target cell is unknown when the handover command is received from the base station by the UE. Therefore, the synchronization and the reporting delay (which contribute to the delay of the handover preparation phase) contribute most to the overall delay. From this perspective optimizing the procedures on the UE side can be seen to be more important than doing network side enhancements in order to improve handovers according to 3GPP.

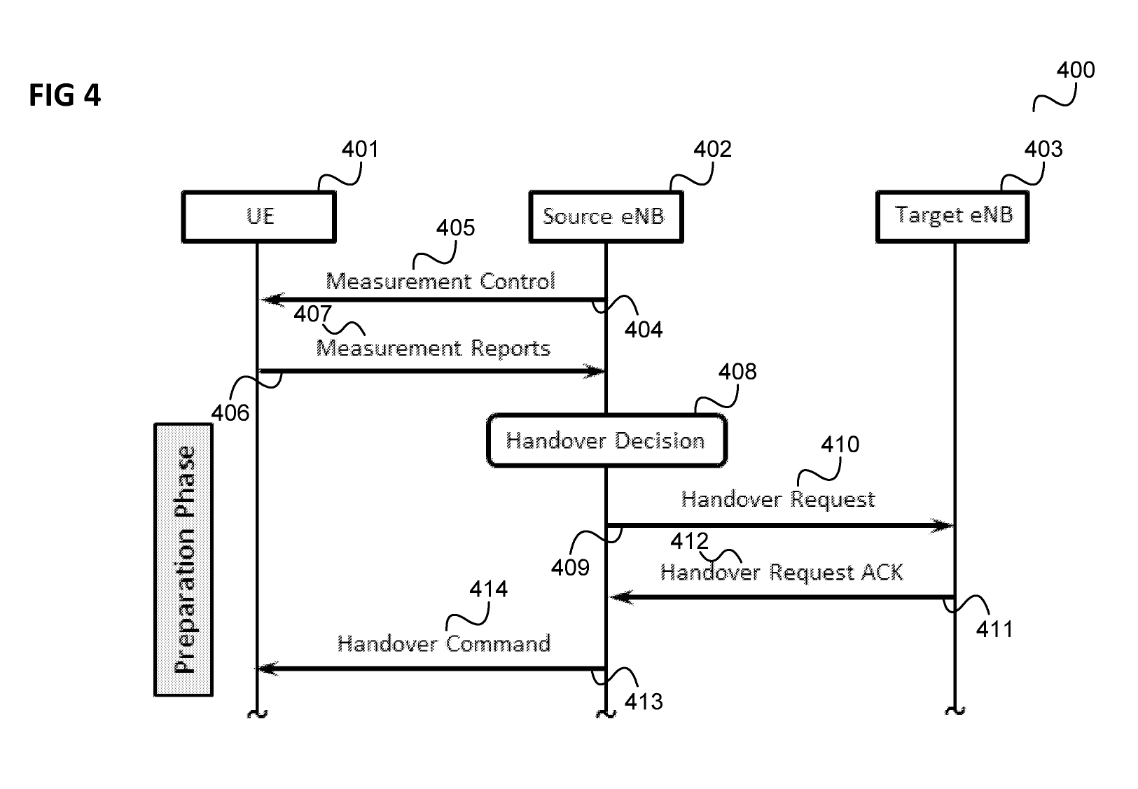

The measurement control and reporting prior to the handover preparation phase as well as the message exchange during the handover preparation according to LTE is illustrated in FIG. 4.

FIG. 4 shows a message flow diagram 400 for a preparation phase.

The message flow takes place between a UE 401, e.g. corresponding to UE 105, a source eNB 402, e.g. corresponding to a base station 103 operating the radio cell 104 via which the UE 105 is currently served (i.e. the serving cell) and target eNB 403, e.g. corresponding to a base station 103 operating the radio cell 104 to which the handover takes place, i.e. the target cell which is going to be the serving cell of the UE 105 after handover.

In 404, the source eNB 402 transmits a measurement control message 405 to the UE 401.

In 406, the UE 401 transmits measurement reports 407 to the source eNB 402.

In this example, it is assumed that in 408, the source eNB 402 decides that a handover to the target cell is to be carried out. This starts the preparation phase.

In 409, the source eNB 402 transmits a handover request 410 to the target eNB 403.

In 411, the source eNB 402 transmits a handover request acknowledgement (ACK) 412 to the source eNB 402.

In 413, the source eNB 402 transmits a handover command 414 to the UE 401.

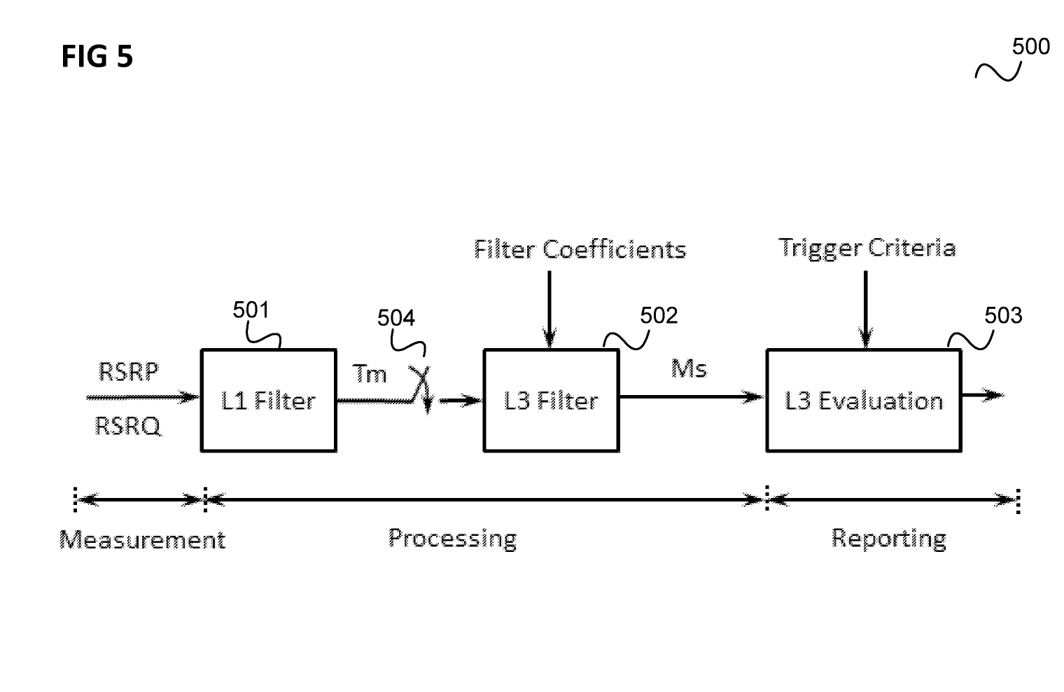

According to 3GPP, a handover is in general based on the DL signal strength and signal to interference measurements related to the serving cell and neighbor cells (i.e. cell neighboring the serving cell, which may include cells located within the serving cell such as femto cells) at the UE. For this, the UE performs measurements and physical layer filtering in layer 1 (according to the ISO/OSI reference model) as illustrated in the FIG. 5.

FIG. 5 shows a measurement processing arrangement 500, e.g. included in communication terminal 105.

The measurement processing arrangement 500 includes a layer 1 filter 501, a layer 3 filter 502 and a layer 3 evaluation circuit 503. The layer 1 filter 501 receives signal measurements such as RSRP (Reference Signal Received Power) or RSRQ (Reference Signal Received Quality) measurements (e.g. from a receiver of the communication terminal). The layer 1 filter 501 filters the measurements (e.g. averages over a plurality of measurements) and provides, for each measurement period of duration Tm (as illustrated by switch 504), the filtering measurements to layer 3 filter 502.

The higher layers (i.e. layer 3 in this example) are responsible for further filtering and for conveying the measurement from the UE to the eNB dependent on network configured trigger criteria. The measurement filtering is mainly done in order to average out the effect of fast fading on the radio link and to minimize the impact of measurement errors.

The layer 3 filter 502 provides the result of the layer 3 filtering to the layer 3 evaluation circuit 503 which checks whether a measurement report trigger criterion is fulfilled.

The measurement report trigger criteria are configured by the network side (e.g. by UTRAN 101) to be used by the UE for reporting a measurement. Each criterion includes an enter condition and a leaving condition. If a certain criterion is met in general or during a period of length timeToTrigger, the UE sends a measurement report to the (serving) eNB including the result of the measurement or measurements. The setting for timeToTrigger may depend on the UE radio environment and velocity of the UE. According to 3GPP, settings between 0 and 5120 ms are supported for timeToTrigger to trade off handover ping pong rates versus handover failures or call drops and reporting overhead.

According to 3GPP Release 8, the following trigger criteria are defined for LTE UEs:
A1: Serving cell becomes better than an absolute threshold
A2: Serving cell becomes worse than an absolute threshold
A3: Neighbor cell becomes an amount of offset better than the serving cell
A4: Neighbor cell becomes better than an absolute threshold
A5: Serving cell becomes worse than an absolute threshold 1 and neighbor cell becomes better than an absolute threshold 2

For the events A1 and A2 no neighbor cell measurements are involved in the triggering, whereas event A3, A4 and A5 require neighbor cell measurements. In addition it should be noted that to reduce UE battery consumption, the UE is only required to do neighbor measurements in case the RSRP of the serving cell falls below a certain threshold which is called the s-Measure in 3GPP specifications.

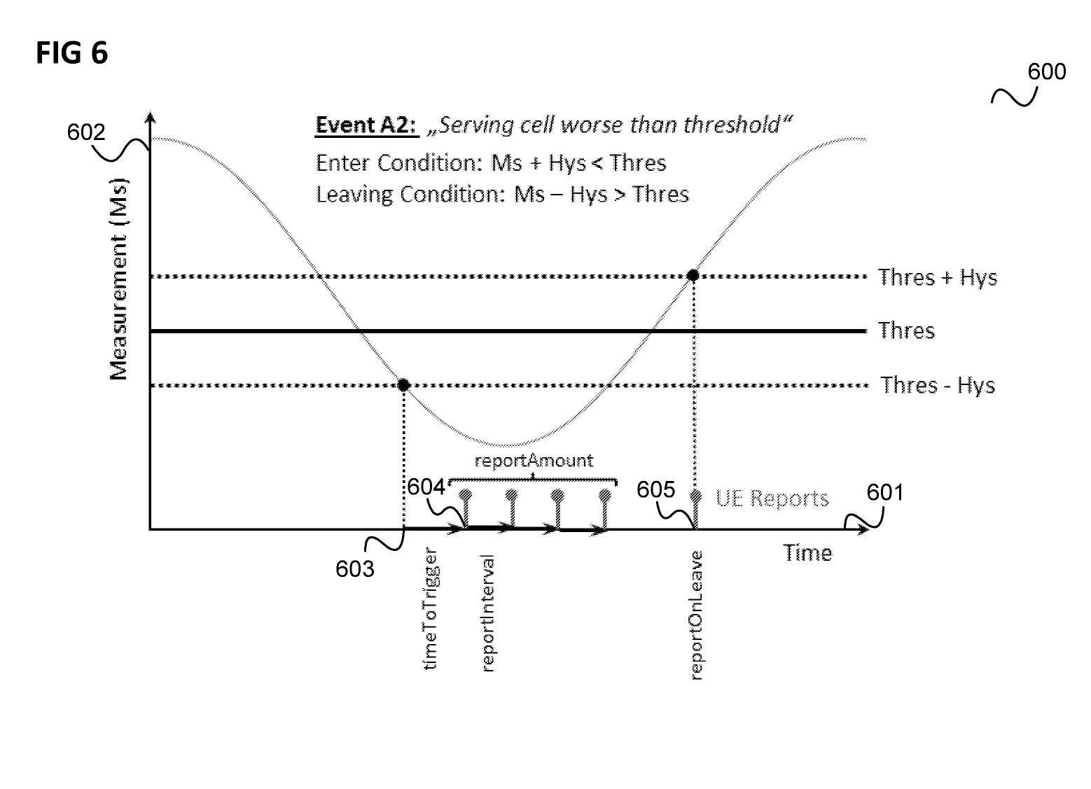

The measurement reporting in case of the A2 trigger criterion is described in the following in more detail with reference to FIG. 6.

FIG. 6 shows a diagram 600 illustrating UE measurement reporting for an A2 event (i.e. an event in which the A2 trigger criterion is fulfilled) according to 3GPP.

In the 600, time increases from left to right along a time axis 601 and the measurement result as output by the layer 3 filter 502 (e.g. a filtered RSRP value or a filtered RSRP value) increases from bottom to top.

In this example, it is assumed that at a first point in time the measurement result Ms falls below a threshold Thres−Hys such that the entering condition according to the A2 triggering criterion Ms+Hys<Thres is fulfilled.

Accordingly, the UE starts a timer and checks whether the criterion is fulfilled during the time timeToTrigger which specifies the time during which the trigger criterion needs to be met in order to trigger a measurement report. After the time timeToTrigger has passed (assuming that the criterion was fulfilled always during this time) the measurement reporting is initiated by the UE at a second point in time 604. Reporting is done periodically per reportIntervall which indicates the interval between periodical reports and has a length of 120 ms to 60 min.

The number of consecutive reports is given by the value reportAmount which may be limited (FIG. 6 illustrates a limitation to four reports) or set to infinity.

It is assumed that at a third point in time 605, leaving condition Ms>Thres+Hys for the A2 trigger event is fulfilled. When this happens, the UE stops reporting and, if the parameter reportOnLeave is set to true, transmits a single report to the network.

According to 3GPP, the measurement period Tm in RRC_CONNECTED state for intra frequency cells is 200 ms if no DRX (Discontinuous Reception) is used. Accordingly, in the example for the A2 event as illustrated in FIG. 6 in worst case, the UE detects the enter condition with a delay of up to 200 ms dependent on the relative timing of the measurements to the enter condition event. This may be critical, especially for future heterogeneous network deployments. In an intra frequency hotspot scenario for example the number of neighbor cells visible to the UE is typically low if the hot spot is close to the serving eNB. Further if ANR (Automatic Neighbor Relation) and eNB power saving is utilized, the hotspot may be still unknown when the handover decision is done at the eNB. Then, on top of the delay due to the measurement timing, a further delay of about 80 ms typically adds up to the handover procedure. In addition there are also delays on the network side e.g. for the downlink path switch and some higher layer signaling. Accordingly, those delays should typically be reduced as far as possible in scenarios where a fast handover is desirable. In other scenarios, where fast handover is not desirable, the delay should typically be increased. Accordingly, it is desirable that the UE can influence the delay e.g. based on local knowledge about the scenario it is in.

As explained above with reference to FIG. 2 a communication terminal is provided that can be seen to report measurements using a dynamic timing raster (namely a timing pattern that may be selected from a plurality of available patterns). In contrast to measuring, filtering and evaluating the radio characteristics (like the RSRP and the RSRQ in LTE) on a fixed timing raster this allows the UE to provide measurements with optimum reporting delay in case the UE has special knowledge of the handover scenario.

Dependent on when the change of the trigger condition from being false to true is happening related to the measurement timing of the UE, the delay between the time when the measurement event entering/leaving condition is fulfilled and the time when the UE initiates the measurement reporting procedure is, for a given measurement timing pattern, random within certain limits. This may be seen to be typical for asynchronous systems (here the external event(s) and the time-discrete evaluation are unsynchronized to each other). The maximum delay depends on the handover measurement period Tₘ which is 200 ms by default and the setting of the timeToTrigger information element.

To achieve a smaller delay (while keeping a fixed measurement pattern), the handover measurement and decision rate may be increased which however leads to a higher UE power consumption.

Further, the trigger time (timeToTrigger) may be selected larger (or smaller) than prescribed by the network in order to advance or delay a handover. However, this is not fully in line with the 3GPP specifications and potentially there could be side effects if the network assumes this value is implemented exactly as prescribed.

Another possibility to reduce the delay is to use interpolation/extrapolation on L1 or L3 and adapt higher layer filter coefficients accordingly and if needed. The communication terminal 200 may go a step further and may adapt the measurement timing within limits from maximum allowed measurement reporting delay in case it is happy with the connection (i.e. wants to keep the serving cell) and minimum achievable measurement reporting delay in case it is unhappy with the connection (i.e. wants to change the serving cell) or expects a better performance in case of handover. For example, if a UE is connected with 3G and detects a 4G hot spot cell it can use a smaller delay. With this (e.g. in addition to delay reduction in critical situations) the connection time to hot spots and next generation base stations may for example be increased.

The communication terminal 200 may for example adapt the apparent radio channel power and/or quality measurement raster on layer 1 (L1) in order to fine tune the handover reporting delay (i.e. to increase or reduce the reporting delay as appropriate). It may do this for example dependent on the situation and specific criteria to identify the situation. For example, it reduces the reporting delay as much as possible if it is getting close to a hot spot which typically provides better data rates compared to the wide area network to which it is currently connected. For this adaptation (e.g. optimization) it may use both interpolation of measurements to increase the delay and extrapolation of measurements to reduce the reporting delay, e.g. based on a set of rules. To the eNB the adaptation or fine-tuning means that the communication terminal 200 appears to operate—from scenario to scenario—on a time shifted measurement or evaluation raster compared to a fixed timing raster.

The communication terminal may for example reduce the reporting delay in the following scenarios/based on the following criteria:
The UE is connected to a wide area cell and approaches a hot spot. The communication terminal may detect this based on the base station transmit power which is typically included in the base station broadcast and system information. A hot spot typically is using a much lower transmission power than a macro cell (˜30 dBm for LTE pico cells vs. ˜46 dBm for LTE macro cells).
The UE knows from some history that the cell with the cell ID (PCI, physical cell ID), which the UE is approaching in the past delivered a high average throughput (e.g. higher than the current average). Further, if the UE detects in addition to the PCI another geographical indication e.g. a know WLAN SSID (service set identifier), the UE can exclude PCI confusion (PCI confusion means the same PCI may be used for several cells, but not cells close by so the confusion can be avoided taking extra information into account).

The communication terminal may for example increase the reporting delay in the following scenarios/based on the following criteria:
The UE is connected to a hot spot and approaches the cell edge there. The UE still tries to keep connection to the hotspot, as long as possible, since the performance of the wide area cell (which would be target of a handover) is known or assumed to be worse. Wide area cell and hot spot can be distinguished via the transmission power as mentioned above. Further, the operator may use different ranges of physical cell IDs for hot spots and wide area cells to support hierarchical deployment specific optimizations at the UE side.
The UE knows from some history that the cell with the cell ID (PCI, physical cell ID) which the UE is approaching in the past delivered a low average throughput (e.g. lower than the current average). Further, if the UE detects in addition to the PCI a known indication of its geographic location, e.g. a WLAN SSID (service set identifier), the UE can exclude PCI confusion and exactly know that the detected PCI is the cell listed in the internal history. It should be noted that besides a combination of PCI and WLAN SSID to avoid PCI confusion also RF fingerprinting (i.e. PCI and PCI environment of the same RAT or PCI and cell IDs of other RATs) can be used as indication of the geographic location.

The approach of adapting the measurement report delay can be expected to be especially beneficial for hierarchical network deployments e.g. in case a UE is approaching or leaving a hot spot or a home base station. In such a case it typically makes sense to push the network to execute a handover as soon as possible or to delay the handover as much as possible to gain from the improved throughput performance the hotspot or home base station is offering.

Examples for the adaptation of the reporting delay are given in the following.

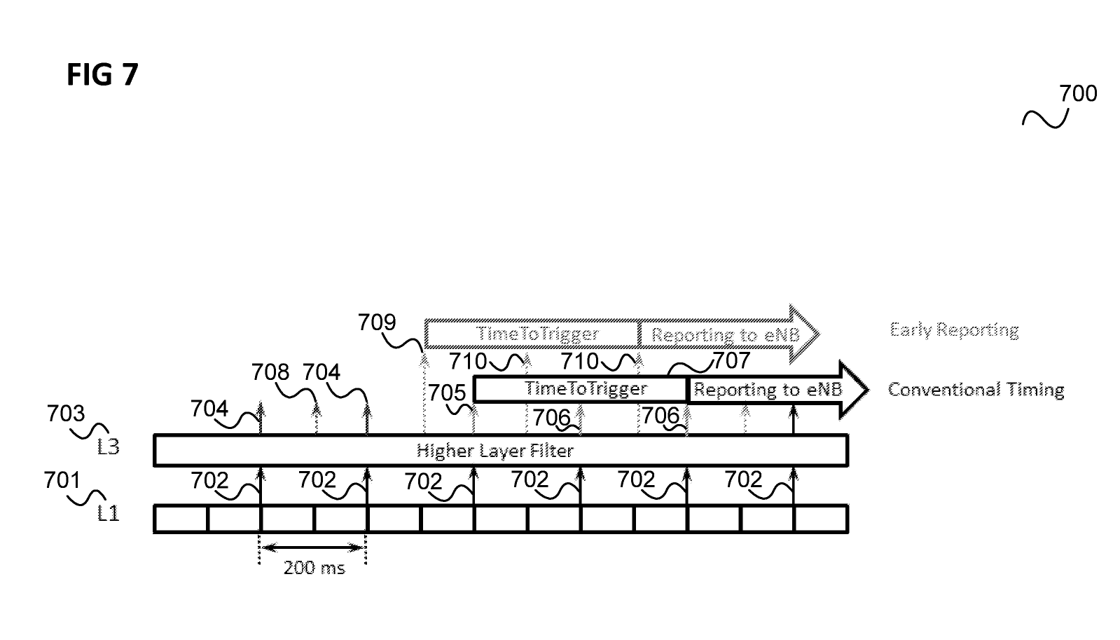

FIG. 7 shows a flow diagram 700 illustrating a reduction of the reporting delay in case of entering the reporting condition (i.e. entering a state in which a trigger criterion is fulfilled).

Time is assumed to increase from left to right.

The communication terminal's layer 1 components, e.g. including layer 1 filter 501, provides measurements 702 periodically every 200 ms (as illustrated in FIG. 5 by switch 504). The measurements for example include measurements of the RSRP of the UEs serving cell or of one or more neighboring cells. Layer 3 (or higher layer) components 703, e.g. including layer 3 filter 502 and layer 3 evaluation circuit 503) filter the measurements and evaluate whether a trigger criterion is met.

In this example, it is assumed that the evaluation of the filtered measurements results, for filtered measurements 704, in that the trigger criterion is not fulfilled but that it is fulfilled for filtered measurements 705, 706. Accordingly, according to the conventional timing, i.e. according to the measurement timing pattern as given by the timing of (physical layer) measurements 702, the communication terminal would start the timeToTrigger period 707, i.e. start the timer for the period of length timeToTrigger until it starts reporting, at the time of the first filtered measurement 705 at which the trigger criterion is fulfilled. According to the conventional timing, the communication terminal would then start reporting when the timeToTrigger period 707 has expired (visualized by the lower block-arrow to the right).

It is assumed in this example that the situation is such that the communication terminal desires to reduce the reporting delay, i.e. to start reporting earlier than at the time of expiry of the timeToTrigger period 707. For this, the communication terminal may perform evaluation of the filtered measurements at additional times to the times of measurements 702.

For example, the layer 3 components 703 evaluates additional filtered measurements 708, 709, 710 for times that lie in between the times of the filtered measurements 704, 705, 706. The additional filtered measurements 708, 709, 710 may for example be generated from the filtered measurements 704, 705, 706 by interpolation or extrapolation of the values of the filtered measurements 704, 705, 706.

Thus, the layer 3 components 703 perform an additional evaluation on the additional filtered measurements 708, 709, 710 (illustrated by dotted arrows) at times corresponding to a shifted sampling raster compared to the raster of the filtered measurements 704, 705, 706 (100 ms time shift).

Assuming in this example that the trigger criterion is already fulfilled at the time of the second additional filtered measurement 709, the communication terminal may start the timeToTrigger period earlier. Accordingly, assuming that the trigger criterion is also fulfilled for the subsequent additional filtered measurements 710, the communication terminal starts reporting earlier than based on the conventional timing. Thus, the reporting delay is reduced compared to the conventional timing.

The communication terminal also uses the shifted or adapted timing pattern (i.e. the timing pattern of additional measurements 708, 709, 710) for the periodic measurement reports (including reportAmount reports) in case reportAmount>1.

It should be noted that instead of generating the additional filtered measurements 708, 709, 710 by extrapolating or interpolating from the filtered measurements 704, 705, 706, the communication terminal may have its L1 components 701 to provide measurements at a higher frequency, e.g. every 100 ms, and the L3 components 703 can perform the additional evaluation based on those measurements. The L1 components 701 may provide these differently filtered values from the same set of basic measurements which may be performed every 100 ms or at another rate, but different filter settings may create measurements at different timing rasters at the interface to the L3 (described also below).

Generating an additional measurement by interpolation may be used by allowing that the timeToTrigger period is started retroactively. For example, the L3 components interpolate the second filtered measurement 704 and the third filtered measurement 705 to generate the second additional filtered measurement 709. This can only be done when the third filtered measurement 705 is already available. If the L3 components determine that the trigger criterion would already have been fulfilled by the second additional filtered measurement 709 the L3 components may start the timeToTrigger period and shorten it as if it had already been started at the time of the second additional filtered measurement 709.

The approach described above can be seen to exploit that the time at which the L3 components detect that the trigger condition is fulfilled does not only depend on the development of the signal strength over time, but also depends on the sampling time (or raster) of the L1 measurements 701: If the sampling time for a measurement 701 is just before the criterion is fulfilled then the L3 components 703 will detect almost 200 ms later that the criterion is fulfilled compared to the case that the sampling time for the measurement happens just after the criterion is fulfilled.

It should be noted that the L1 measurements 702 may be based themselves on an averaging of measurements that are taken more frequently than every 200 ms. The communication terminal may shift the raster according to which these measurements are averaged to delay or advance the measurement reporting.

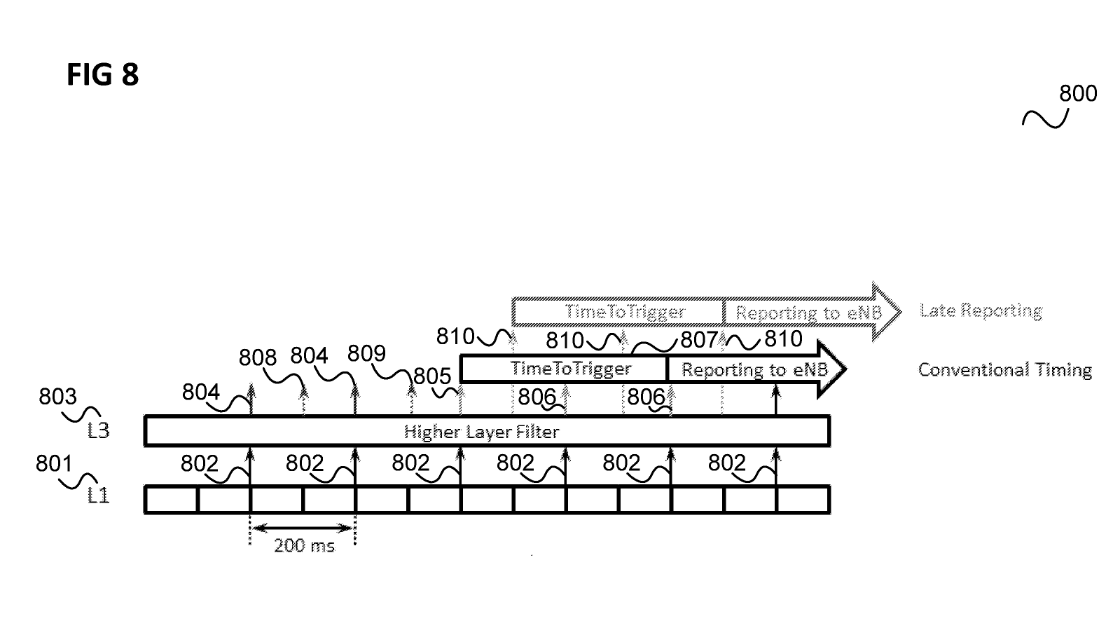

FIG. 8 shows a flow diagram 800 illustrating a reduction of the reporting delay in case of entering the reporting condition.

Time is assumed to increase from left to right.

Similarly to FIG. 7, the communication terminal's layer 1 components provide measurements 802 periodically every 200 ms and layer 3 (or higher layer) components 803 filter the measurements and evaluate whether a trigger criterion is met.

As in the example of FIG. 7 it is assumed that the evaluation of the filtered measurements results, for filtered measurements 804, in that the trigger criterion is not fulfilled but that it is fulfilled for filtered measurements 805, 806. Accordingly, according to the conventional timing the communication terminal would start the timeToTrigger period 807 at the time of the first filtered measurement 805 at which the trigger criterion is fulfilled. According to the conventional timing, the communication terminal would then start reporting when the timeToTrigger period 807 has expired.

It is assumed in this example that the situation is such that the communication terminal desires to increase the reporting delay. For this, as explained above with reference to FIG. 7, the layer 3 components 803 perform an additional evaluation on additional filtered measurements 808, 809, 810 (illustrated by dotted arrows) at times corresponding to a shifted sampling raster compared to the raster of the filtered measurements 804, 805, 806 (100 ms time shift).

Assuming in this example that the trigger criterion is not yet fulfilled at the time of the second additional filtered measurement 809, the communication terminal may start the timeToTrigger period earlier. Accordingly, assuming that the trigger criterion is also fulfilled for the subsequent additional filtered measurements 810, the communication terminal accordingly starts reporting later than based on the conventional timing by considering only the result of the evaluation of the additional filtered measurements 808, 809, 810. Thus, the reporting delay is increased compared to the conventional timing.

As in the case of decreased reporting delay explained above with reference to FIG. 7, the communication terminal also uses the shifted or adapted timing pattern (i.e. the timing pattern of additional measurements 810) for the periodic measurement reports (including reportAmount reports) in case reportAmount>1.

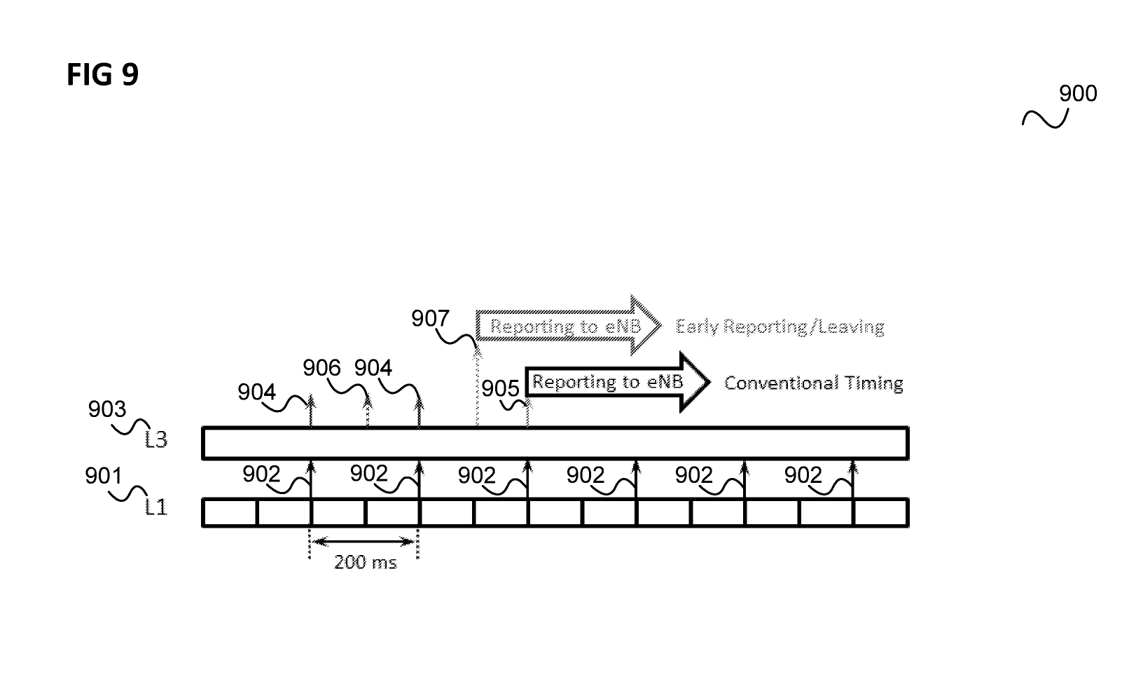

FIG. 9 shows a flow diagram 900 illustrating a reduction of the reporting delay in case of leaving the reporting condition (i.e. entering a state in which the leaving condition is fulfilled).

Time is assumed to increase from left to right.

Similarly to FIG. 7, the communication terminal's layer 1 components 901 provide measurements 902 periodically every 200 ms. Layer 3 (or higher layer) components 903 filter the measurements and evaluate whether the leaving condition is met.

In this example, it is assumed that the evaluation of the filtered measurements results, for filtered measurements 904, in that the leaving is not fulfilled but that it is fulfilled for filtered measurements 905. Accordingly, according to the conventional timing, i.e. according to the measurement timing pattern as given by the timing of measurements 902, the communication terminal would report to the eNB at the time of the first filtered measurement 905 at which the leaving condition is fulfilled.

It is assumed in this example that the situation is such that the communication terminal desires to reduce the reporting delay, i.e. to start reporting (on leaving) earlier than at the time of the first filtered measurement 905 at which the leaving condition is fulfilled. For this, as explained with reference to FIG. 7, the communication terminal may perform evaluation of the filtered measurements at additional times to the times of measurements 902.

For example, the layer 3 components 903 evaluate additional filtered measurements 906, 907 for times that lie in between the times of the filtered measurements 904, 905.

Thus, the layer 3 components 903 perform an additional evaluation on the additional filtered measurements 906, 907 (illustrated by dotted arrows) at times corresponding to a shifted sampling raster compared to the raster of the filtered measurements 904, 905 (100 ms time shift).

Assuming in this example that the leaving condition is already fulfilled at the time of the second additional filtered measurement 907, the communication terminal may report earlier, i.e. with lower reporting delay.

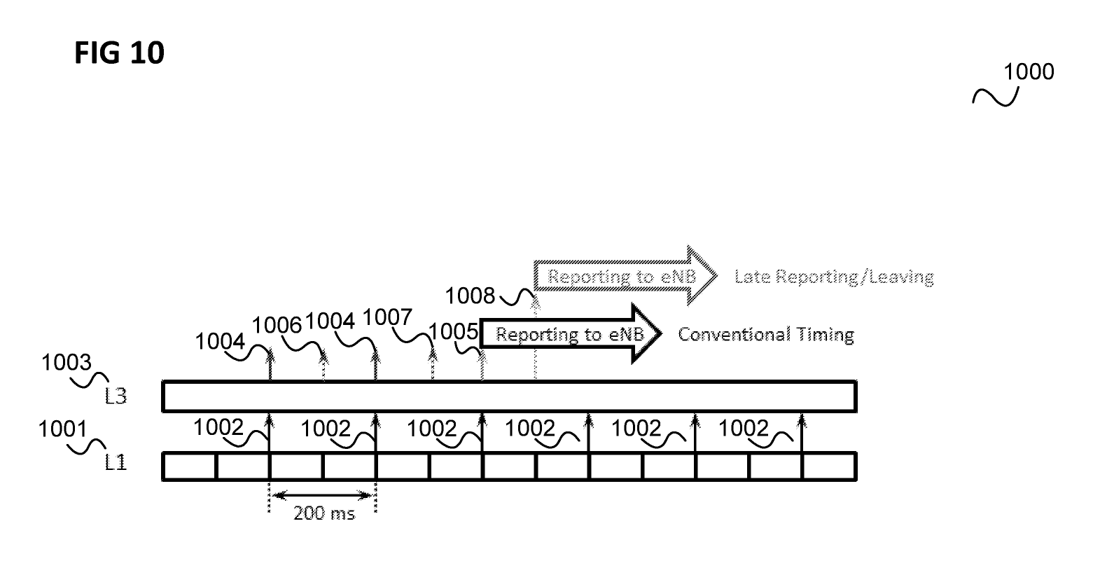

FIG. 10 shows a flow diagram 1000 illustrating an increase of the reporting delay in case of leaving the reporting condition.

Time is assumed to increase from left to right.

Similarly to FIG. 9, the communication terminal's layer 1 components 1001 provide measurements 1002 periodically every 200 ms. Layer 3 (or higher layer) components 1003 filter the measurements and evaluate whether the leaving condition is met.

As in the example of FIG. 9, it is assumed that the evaluation of the filtered measurements results, for filtered measurements 1004, in that the leaving is not fulfilled but that it is fulfilled for filtered measurements 1005. Accordingly, according to the conventional timing, i.e. according to the measurement timing pattern as given by the timing of measurements 1002, the communication terminal would report to the eNB at the time of the first filtered measurement 1005 at which the leaving condition is fulfilled.

It is assumed in this example that the situation is such that the communication terminal desires to increase the reporting delay, i.e. to start reporting (on leaving) later than at the time of the first filtered measurement 1005 at which the leaving condition is fulfilled. For this, as explained with reference to FIG. 7, the communication terminal may perform evaluation of the filtered measurements at additional times to the times of measurements 1002.

For example, the layer 3 components 1003 evaluates additional filtered measurements 1006, 1007 for times that lie in between the times of the filtered measurements 1004, 1005.

Thus, the layer 3 components 1003 perform an additional evaluation on the additional filtered measurements 1006, 1007, 1008 (illustrated by dotted arrows) at times corresponding to a shifted sampling raster compared to the raster of the filtered measurements 1004, 1005 (100 ms time shift).

Assuming in this example that the leaving condition is not yet fulfilled at the time of the second additional filtered measurement 1007, the communication terminal may report later, i.e. with higher reporting delay, at the time of the third additional filtered measurement 1008 by considering only the results of the evaluation of the additional filtered measurements 1006, 1007, 1008.

As mentioned above, instead of evaluation of interpolated or extrapolated filtered measurements, the layer 3 components may evaluate measurements provided by the layer 1 components in parallel on two (or more) sampling rasters (e.g. a plurality of rasters including measurements every 200 ms), which are shifted relative to each other (e.g. two rasters which are shifted by 100 ms to each other, four rasters which are 50 ms, 100 ms and 150 ms to each other etc.). Depending on whether early/late reporting is desired, the communication terminal selects a raster (also referred to as measurement timing pattern) that indicates a report earlier/later according to which it performs measurement reporting.

Evaluation of measurements at two rasters requires twice the computing effort compared to handling measurements of a single raster only. However, the communication terminal may for example only perform the evaluation of the measurements of the second raster if the processing at the first raster indicates that a reporting may happen soon (e.g. when the trigger condition is fulfilled almost as often as required to start reporting, e.g. for all measurement times except one during the timeToTrigger period). The communication terminal for example only then inspects the measurements of the second (additional) raster and checks whether that raster would be more appropriate. For example, when the reporting should be delayed, the communication terminal performs this check when the measurements of the first raster indicate fulfillment of the trigger condition to determine whether the second raster could then allow the communication terminal to not report immediately.

In the examples illustrated in FIGS. 7 to 10 the communication terminal evaluates additional (filtered) measurements at an additional raster which is shifted by 100 ms with respect to the physical layer measurement raster. The communication terminal selects the raster according to which it performs measurement reporting from among the physical layer measurement raster and the additional raster.

Instead of evaluating a fixed additional raster (as in the examples of FIGS. 7 to 10 where the additional raster has a fixed 100 ms time shift) the communication terminal may also for example dynamically determine an additional raster based on the time when a trigger criterion or a leaving condition is fulfilled. For example, by interpolating the second filtered measurement 704 and the third filtered measurement 705 (e.g. by assuming a linear decrease of the measurement value) the communication terminal may estimate the time when the measurement value for the first time just fulfills the trigger criterion, e.g. is below Thres-Hys as illustrated in FIG. 6. The communication terminal may then set this estimated time as the time of a measurement according to an additional raster and determine the additional raster as including this time and times that are an integer multiple of 200 ms from this time. Thus, the communication terminal can start the timeToTrigger period as early as possible and consequently also start reporting as early as possible.

Similarly, to delaying reporting, the communication terminal may set a time just before the estimated time as the time of a measurement according to an additional raster and determine the additional raster as including this time and times that are an integer multiple of 200 ms from this time. Thus, the communication terminal can start the timeToTrigger period as late as possible and consequently also start reporting as late as possible.

The communication terminal may similarly tune the timing (i.e. determine and select the additional raster) so that the leaving reporting is done as early as possible (exactly at the time when the leaving condition can be fulfilled first) or as late as possible.

It should be noted that by performing measurement reporting according to a selected raster (i.e. measurement timing pattern), the communication terminal can be seen to pretend toward the base station that it operates on the selected raster.

While specific aspects have been described, it should be understood by those skilled in the art that various changes in form and detail may be made therein without departing from the spirit and scope of the aspects of this disclosure as defined by the appended claims. The scope is thus indicated by the appended claims and all changes which come within the meaning and range of equivalency of the claims are therefore intended to be embraced.

1. A communication terminal comprising
a measurement reporting circuit configured to report a plurality of cell measurement results based on a measurement timing pattern;
a determiner configured to determine a first candidate measurement timing pattern and a second candidate measurement timing pattern, each measurement timing pattern comprising a plurality of measurement times, wherein the second measurement timing pattern comprises at least one measurement time occurring between a plurality of measurement times of the first candidate measurement timing pattern;
a selector configured to select, from the first candidate measurement timing pattern and the second candidate measurement timing pattern, a measurement timing pattern with a measurement time
at which a result of a measurement fulfills a reporting criterion, and
which fulfills a predetermined condition; and
a controller configured to control the measurement reporting circuit to report the plurality of cell measurement results based on the selected measurement timing pattern.

2. The communication terminal according to claim 1, wherein the determiner is configured to determine at least one further candidate measurement timing pattern, wherein the at least one further candidate measurement timing pattern comprises at least one measurement time occurring between a plurality of measurement times of the first candidate measurement timing pattern and comprises at least one measurement time occurring between a plurality of measurement times of the second candidate measurement timing pattern.

3. The communication terminal according to claim 1, wherein the reporting criterion is a criterion for triggering a reporting of the plurality of cell measurement results.

4. The communication terminal according to claim 1, wherein the measurement reporting circuit is configured to report the plurality of cell measurement results to a base station.

5. The communication terminal according to claim 1, wherein the predetermined condition is that, for a given fulfillment of the reporting criterion, the measurement time of the measurement timing pattern is the earliest time at which the result of the measurement fulfills the reporting criterion among the times included in the candidate measurement timing patterns.

6. The communication terminal according to claim 1, wherein the predetermined condition is that, for a given fulfillment of the reporting criterion, the measurement times of the measurement timing pattern comprise the latest time at which the result of a measurement has yet to fulfill the reporting criterion among the times included in the candidate measurement timing patterns and the measurement time is the first time of the measurement timing pattern following the latest time.

7. The communication terminal according to claim 1, wherein the determiner is configured to determine the first candidate measurement timing pattern by determining the measurement timing pattern of a physical layer component of the communication terminal as the first candidate measurement timing pattern.

8. The communication terminal according to claim 1, wherein the determiner is configured to determine the second candidate measurement timing pattern by shifting the first candidate measurement timing pattern by a time interval less than the time interval between a plurality of measurement timings of the first candidate measurement timing pattern.

9. The communication terminal according to claim 1, wherein determining the second candidate measurement timing pattern comprises estimating the time at which a result of a measurement fulfills a reporting criterion and determining the second candidate measurement timing based on the estimated time.

10. The communication terminal according to claim 9, wherein the determiner is configured to determine the second candidate measurement timing pattern to include the estimated time.

11. The communication terminal according to claim 9, wherein the determiner is configured to determine the second candidate measurement timing pattern to exclude the estimated time.

12. The communication terminal according to claim 9, wherein the determiner is configured to determine the second candidate measurement timing pattern to include a measurement time before the estimated time but after the latest measurement timing of the first candidate measurement timing before the estimated time.

13. The communication terminal according to claim 1, wherein the first candidate measurement timing and the second candidate measurement timing are periodic.

14. The communication terminal according to claim 1, wherein the communication terminal is configured to operate based on a communication standard that specifies the time interval between a plurality of measurement times of a measurement timing pattern used for reporting measurements.

15. The communication terminal according to claim 1, wherein the measurement results are results of measurements for evaluating whether the communication terminal is to perform a handover.

16. The communication terminal according to claim 1, wherein the measurement is the measurement of the reception power or the reception quality of a signal at the communication terminal and the reporting criterion is whether the reception power or the reception quality is above or below a predetermined threshold.

17. The communication terminal according to claim 1, wherein the communication terminal is a user equipment according to an LTE specification.

18. The communication terminal according to claim 1, wherein the first candidate measurement timing pattern is a measurement timing pattern according to which the measurement reporting circuit has previously reported cell measurement results.

19. The communication terminal according to claim 1, wherein the measurement reporting circuit is configured to report the plurality of cell measurement results to an eNB according to an LTE specification.

20. A method for reporting measurement results comprising
determining a first candidate measurement timing pattern and a second candidate measurement timing pattern, each measurement timing pattern comprising a plurality of measurement times, wherein the second measurement timing pattern comprises at least one measurement time occurring between a plurality of measurement times of the first candidate measurement timing pattern;
selecting, from the first candidate measurement timing pattern and the second candidate measurement timing pattern, a measurement timing pattern with a measurement time
at which a result of a measurement fulfills a reporting criterion, and which
fulfills a predetermined condition; and
reporting a plurality of cell measurement results based on the selected measurement timing pattern.

21. A computer readable medium having recorded instructions thereon which, when executed by a processor, make the processor perform a method for performing radio communication according to claim 20.
